(19) United States
(12) Patent Application Publication
(10) Pub. No.: US 2026/0318423 A1
(43) Pub. Date: Oct. 15, 2026

(54) Valve with Improved Sealing Element and Use of the Valve

(71) Applicant: Viega Technology GmbH & Co. KG, Attendorn (DE)

(72) Inventors: David Jung, Neunkirchen (DE); Yannik Holz, Olpe (DE); Verena Stelthove, Lennestadt (DE)

(21) Appl. No.: 19/421,177

(22) Filed: Dec. 16, 2025

(30) Foreign Application Priority Data
Dec. 20, 2024 (DE) 10 2024 139 445.5

(51) Int. Cl. F16K 5/06

(52) U.S. Cl. CPC F16K 5/0689

(57) ABSTRACT

A valve, in particular ball valve, with a valve housing that has at least a first opening and a second opening, between which an internal channel runs, and with a shut-off body arranged in the valve housing, which can be adjusted to regulate, in particular to shut off or allow the passage of, a fluid flow through the internal channel. A sealing element is arranged between the valve housing and the shut-off body and the sealing element has an elastic sealing lip, wherein the elastic sealing lip and the shut-off body are designed and arranged relative to each other such that the elastic sealing lip is in an initial state when the shut-off body is in a first position, in particular in a first target position of the valve, and that the elastic sealing lip is in a deformed state relative to the initial state when the shut-off body is in a second position, in particular in a second target position of the valve. The invention further relates to the use of the valve for a drinking water installation.

### CROSS-REFERENCE TO RELATED APPLICATION

This application claims priority to German Patent Application No. 102024139445.5 filed Dec. 20, 2024, the disclosure of which is hereby incorporated by reference in its entirety.

### BACKGROUND OF THE INVENTION

### Field of the Invention

The present invention relates to a valve, in particular a ball valve, comprising a valve housing that has at least a first opening and a second opening, between which an internal channel runs, and comprising a shut-off body arranged in the valve housing, which can be adjusted to regulate, in particular to shut off or allow the passage of, a fluid flow through the internal channel, wherein a sealing element is arranged between the valve housing and the shut-off body. The invention further relates to a use of the valve.

### Description of Related Art

Ball valves are frequently used in drinking water installations. A ball valve, which is also referred to as a ball tap or ball shut-off valve, is a valve with a drilled-through spherical shut-off body. By rotating the shut-off body, the ball valve can be opened or closed, whereby complete closure typically requires only a rotation of about 90°.

In ball valves, there is the problem that fluid conducted through the internal channel of the ball valve can enter the gap (dead space) between the shut-off body and the valve housing, which can lead to hygiene problems, since the fluid stagnates in the gap and the gap is difficult to clean. Furthermore, it is possible that, in the closed position of the valve, fluid can pass through the gap past the shut-off body. Therefore, sealing elements are used to seal the internal channel in the region of the transition between the valve housing and the shut-off body.

For such sealing elements, sealing materials containing per-and polyfluorinated alkyl substances (PFAS), such as polytetrafluoroethylene (PTFE), are often used. However, PFAS-containing materials are suspected of being harmful to health, so there is a need to reduce the use of PFAS-containing materials, particularly in the field of drinking water.

In addition, when ball valves are used in drinking water installations, contamination of the sealing seat, i.e., the contact between the sealing element and the shut-off body, can occur, especially if the drinking water in the installation has a high mineral content. Contamination at the sealing seat can lead to a significant increase in the torque required to operate the ball valve and may even make it impossible to operate the ball valve without damage.

Moreover, ball valves with sealing elements in particular require relatively high torques for their operation, i.e., for adjusting the shut-off body. In particular, the creep properties of the rubber or plastic of conventional sealing elements, especially at high operating temperatures such as in hot water pipes, lead to high breakaway torques if a ball valve is not operated for an extended period during use. This can result in damage to the sealing element, leading to leakage.

Furthermore, desired automatic operation of a ball valve requires relatively large actuators due to the high torques and breakaway torques required to operate the ball valve, which leads to increased installation space requirements and higher costs.

In a shut-off body actuated by an electric or hydraulic actuator, increases in the torque required for operation that occur over the service life, for example due to contamination, can exceed the maximum output of the electric or hydraulic system and thus prevent rotation of the shut-off body. Increases in the torque required for operation can also lead to premature wear of the various elements of the ball valve.

### SUMMARY OF THE INVENTION

Against this background, the object of the present invention is to provide a valve, in particular a ball valve, that at least partially reduces or avoids at least some of the disadvantages of the prior art described above.

In particular, a valve is to be provided that is better suited for the use of PFAS-free materials. In particular, a valve with a seal is to be proposed that enables better material selection without requiring compromises in assembly technology or sealing performance compared to the prior art.

The above-mentioned object is achieved according to the invention by a valve, in particular a ball valve, comprising a valve housing that has at least a first opening and a second opening, between which an internal channel runs, and comprising a shut-off body arranged in the valve housing, which can be adjusted to regulate, in particular to shut off or allow the passage of, a fluid flow through the internal channel, wherein a sealing element is arranged between the valve housing and the shut-off body, wherein the sealing element has an elastic sealing lip, and wherein the elastic sealing lip and the shut-off body are designed and arranged relative to each other such that the elastic sealing lip is in an initial state when the shut-off body is in a first position, and that the elastic sealing lip is in a deformed state relative to the initial state when the shut-off body is in a second position.

If a sealing lip remains in a deformed state for a long period of time, possibly for years, this can result in the sealing lip remaining in a deformed state even without external force being applied, so that when the shut-off body is moved to another position, leaks may occur because the sealing lip no longer seals properly. Such remaining in a deformed state is also referred to as compression set and occurs with many elastomers. In the case of a compression set of 100%, which can occur especially after a very long time in the deformed state, the sealing lip permanently remains in the deformed shape, i.e., in the second state. If the sealing lip is in the deformed state only for a very short time, it generally returns completely to its original state when relieved (0% compression set). Leaks can already occur at a compression set below 100%, for example if the sealing lip, after a longer period in the deformed state, has a compression set of 50%.

In the valve described above, the sealing lip is in an initial state when the shut-off body is in the first position, with the deformation from the initial state to the deformed state only occurring when the shut-off body is moved from the first position to the second position. In this way, the sealing lip can reliably seal in the second position, even if the shut-off body is moved for the first time after a long period.

In this way, the valve can be actuated easily after a long period of inactivity, without leaks or damage occurring. In particular, breakaway and actuating torques can be reduced in this way, since the sealing lip is in the initial state in the first position, so that breaking the sealing lip free when moving from the first position is not necessary or only requires a small force. This in particular enables the use of a smaller actuating element, for example a smaller lever, or a smaller actuator, in particular a motor, for this purpose. As a result, the valve can be designed to be more cost-effective, energy-efficient, and space-saving. The valve is particularly advantageous in the case of unavoidable contamination during operation, such as lime deposits.

Furthermore, if the first position is an open position and the second position is a closed position of the valve, secure sealing when closing the valve can be ensured even after a long period in the first, open position, since the elastic sealing lip is in an initial state in the first position, preferably is unloaded, and thus has no or only a minor compression set, so that the elastic sealing lip can reliably seal when moved to the second, closed position.

The use of an elastic sealing lip also promotes the removal of any deposits on the sealing lip or between the sealing lip and the shut-off body.

The valve may in particular be a ball valve (ball tap). Accordingly, the shut-off body may in particular be spherical in shape.

The valve comprises a valve housing that has at least a first opening and a second opening. It is also conceivable that the valve housing has more than two openings, for example in the case of a multi-way valve.

An internal channel runs between the first and second opening. In particular, a fluid, for example water, can be conducted through the internal channel from the first opening to the second opening or vice versa.

The valve further comprises a shut-off body arranged in the valve housing, which can be adjusted to regulate, in particular to shut off or allow the passage of, a fluid flow through the internal channel. For this purpose, the shut-off body may in particular be arranged in the internal channel and be designed to locally change, in particular reduce, the cross-section of the internal channel by adjusting the shut-off body, whereby the fluid flow through the internal channel can be reduced. Preferably, the cross-section of the internal channel can be reduced to zero by adjusting the shut-off body, so that the fluid flow through the internal channel can be completely blocked (shut off). The shut-off body may in particular have a shut-off body inner channel, which forms a section of the internal channel running between the first and second opening and which can be adjusted, for example rotated, relative to one or more remaining sections of the internal channel. By rotating the shut-off body inner channel relative to the one or more remaining sections of the internal channel, the cross-section of the internal channel can be changed, in particular reduced, for example to zero.

In particular, the shut-off body can be adjusted to shut off or allow the passage of a fluid flow through the internal channel, for example if the valve is a shut-off valve, in particular a ball valve. In this case, the shut-off body may have two intended target positions, namely an open position for allowing the passage of the fluid flow and a closed position for shutting off the fluid flow. When moving the shut-off body between these two target positions, the shut-off body may also assume intermediate positions in which the fluid flow is reduced compared to the open position, but not yet completely shut off. It may be provided, in particular in the case of a ball valve, that these intermediate positions do not represent regular operating positions in which the valve is intended to be operated.

Accordingly, the shut-off body can be adjusted between a first and a second target position, in particular between an open target position and a closed target position of the valve. The open target position in particular corresponds to the position in which the valve is maximally open.

The first position may in particular be the first target position of the valve, and the second position may in particular be the second target position of the valve. Preferably, the first position is the open target position and the second position is preferably the closed target position of the valve.

In this way, the elastic sealing lip is in an initial state, in particular an unloaded state, when the shut-off body is in the first target position, preferably the open target position, and in a deformed state relative to the initial state when the shut-off body is in the second target position, preferably the closed target position.

In particular, the open target position may be a first rotational position of the shut-off body and the closed target position may be a second rotational position of the shut-off body. The first and second rotational positions of the shut-off body may, for example, be rotated relative to each other by 70-110°, in particular 90°.

The shut-off body is in particular mounted in the valve housing such that it is adjustable, preferably rotatably mounted.

A sealing element is arranged between the valve housing and the shut-off body. In this way, the internal channel can be sealed at a transition point from the valve housing to the shut-off body. In particular, the sealing element can prevent fluid, in particular water, from the internal channel from entering a gap between the shut-off body and the valve housing in the first and/or second position of the shut-off body. In this way, in particular in a closed position of the shut-off body, it can be prevented that fluid passes through a gap between the shut-off body and the valve housing around the shut-off body.

The sealing element, the valve housing, and the shut-off body may be designed such that a gap present between the valve housing and the shut-off body is flowable by a fluid conducted through the internal channel in at least one position of the shut-off body, in particular in an intermediate position between the first and second position and/or in an intermediate position between the open and closed position. For this purpose, the gap in the at least one position of the shut-off body, in particular intermediate position, can be fluidically connected on both sides to the internal channel, for example. In this way, it is achieved that the gap is at least sporadically flushed with fluid, for example when the valve is moved from the first to the second position or vice versa. This can counteract contamination or microbial growth in the valve due to permanently stagnant water.

The valve housing preferably has a receptacle for the sealing element, in which the sealing element is arranged. In this way, the sealing element can be securely held between the valve housing and the shut-off body.

Preferably, the sealing element is arranged circumferentially between the valve housing and the shut-off body in the circumferential direction of the internal channel. The sealing element may in particular be annular.

The sealing element has an elastic sealing lip. In cross-section, the sealing lip preferably extends away from the remainder of the sealing element, in particular in the direction of the shut-off body and/or in the direction of the valve housing. Preferably, the sealing lip runs circumferentially between the valve housing and the shut-off body in the circumferential direction of the internal channel.

The elastic sealing lip and the shut-off body are designed and arranged relative to each other such that the elastic sealing lip is in an initial state when the shut-off body is in a first position. The initial state may, for example, be an undeformed or a slightly deformed state. In this way, no or only minor deformation forces act on the sealing lip in the first position of the shut-off body, so that permanent deformation of the sealing lip, for example if the shut-off body remains in the first position for a long period, is reduced or avoided.

The first position of the shut-off body is preferably an open position of the valve, in which the shut-off body does not or only slightly reduces the cross-section of the internal channel. However, the first position of the shut-off body may also be a partially open position, in which the shut-off body reduces the cross-section of the internal channel to a greater extent, or a closed position of the valve, in which the shut-off body reduces the cross-section of the internal channel to zero, i.e., completely blocks the internal channel.

The elastic sealing lip and the shut-off body are further designed and arranged relative to each other such that the elastic sealing lip is in a deformed state relative to the initial state when the shut-off body is in a second position. In the second position, the sealing lip in particular provides a seal to the shut-off body and/or to the valve housing, in particular between the internal channel and any gap between the shut-off body and the valve housing. The sealing lip is thus deformed from the initial state to the deformed state in particular when the shut-off body is moved from the first position to the second position, in particular by the sealing lip being pressed against the shut-off body or the valve housing. The elasticity of the sealing lip, when deformed from the initial state, in particular produces a force counteracting the deformation, by which the sealing lip is pressed in particular against the shut-off body or the valve housing, thereby achieving good sealing.

Preferably, the sealing lip is designed and arranged such that, in the second position, the sealing lip forms a concave region toward the internal channel, in particular in a region opposite the contact surface of the sealing lip to the shut-off body and/or valve housing, i.e., the sealing seat. In this way, the pressure of a fluid present in or flowing through the internal channel on the sealing lip in the concave region leads to an increase in the contact pressure of the sealing lip against the shut-off body and/or valve housing. This can achieve improved sealing.

The second position of the shut-off body is preferably a closed position of the valve, in which the shut-off body reduces the cross-section of the internal channel to zero, i.e., completely blocks the internal channel. However, the second position of the shut-off body may also be a partially open or open position of the valve.

The object is further achieved according to the invention by the use of the valve described above or an embodiment thereof for a gas installation or drinking water installation.

Various embodiments of the valve and its use are described in the following, wherein the individual embodiments each apply independently from each other to both, the valve and its use. Furthermore, the individual embodiments can be combined with one another in any desired manner.

In one embodiment, the elastic sealing lip, in the deformed state, preferably under pre-tension, rests against the shut-off body or the valve housing, preferably against the shut-off body. When the sealing lip is deformed by contact with the shut-off body or the valve housing as the shut-off body is moved into the second position, this produces a counterforce opposing the deformation, so that the elastic sealing lip, in the second position of the shut-off body, rests under pre-tension against the shut-off body or the valve housing. In this way, good sealing to the shut-off body or to the valve housing is achieved. If the sealing lip, in the deformed state, rests against the shut-off body, the sealing lip and the shut-off body are preferably spaced apart from each other in the first position of the shut-off body. If the sealing lip, in the deformed state, rests against the valve housing, the sealing lip and the valve housing are preferably spaced apart from each other in the first position of the shut-off body.

In one embodiment, the sealing element has a further elastic sealing lip, wherein the further elastic sealing lip and the shut-off body are designed and arranged relative to each other such that the further elastic sealing lip, preferably under pre-tension, rests against the shut-off body or the valve housing, preferably against the shut-off body, when the shut-off body is in the first position. The further sealing lip may, for example, serve to hold the shut-off body in position in the first position. Additionally or alternatively, the further sealing lip may provide sealing in the first position of the shut-off body.

With the elastic sealing lip and the further elastic sealing lip, the sealing element according to this embodiment thus has two sealing lips, of which, preferably in the first and second positions, more preferably also in an intermediate position between the first and second positions, in particular in every position of the shut-off body, at least one is engaged, i.e., rests against the shut-off body and/or the valve housing. In this way, the shut-off body, in particular a spherical shut-off body, can be held in position in the first and second positions, and preferably also in intermediate positions.

It is conceivable that the further sealing lip, in the second position of the shut-off body, is in an initial state with less deformation or no deformation compared to the state of the further sealing lip in the first position of the shut-off body. In this way, the sealing lip and the further sealing lip can alternate in their respective sealing function as the shut-off body is moved between the first and second positions, so that when moving to the first position as well as when moving to the second position, a respective sealing lip is deformed from its respective initial state, thereby achieving good sealing in both positions.

Furthermore, it is conceivable that the further sealing lip rests against the shut-off body or the valve housing, preferably under pre-tension, in both the first and second positions. In this way, the further sealing lip can, for example, serve to hold and, if necessary, support the shut-off body in both the first and second positions, in particular if the shut-off body is spherical. In this configuration, in the first position, in particular the open position, of the shut-off body, preferably at least the further sealing lip rests against the shut-off body and/or the valve housing, preferably against the shut-off body, and in the second position, in particular the closed position, of the shut-off body, preferably both, the sealing lip and the further sealing lip, rest against the shut-off body and/or the valve housing, preferably against the shut-off body.

In one embodiment, the sealing element has one or more openings as a bypass for the further elastic sealing lip. In particular, the sealing element may have one or more channels or perforations. The one or more openings serve as a bypass for the further elastic sealing lip. In this way, the one or more openings provide a fluid connection between the internal channel and a gap present between the valve housing and the shut-off body when, in the first position, only the further elastic sealing lip rests against the shut-off body and/or the valve housing. This ensures that the gap between the valve housing and the shut-off body, in the first position, preferably the open position, is flushed with fluid flowing through the internal channel, thereby preventing stagnant fluid, in particular water, in the gap in the first position. In this way, contamination or microbial growth in the gap can be avoided.

In one embodiment, the shut-off body is rotatably mounted in the valve housing, in particular about a rotational axis, wherein the shut-off body preferably has a shut-off body inner channel. The shut-off body may in particular be spherical in shape. The valve may accordingly be a ball valve. Correspondingly, the first position of the shut-off body may be a first rotational position and the second position of the shut-off body may be a second rotational position.

A rotatable shut-off body in particular allows continuous regulation of the fluid flow, especially between an open and a closed position of the valve. The shut-off body inner channel is rotated relative to the one or more remaining sections of the internal channel as the shut-off body is rotated, whereby the cross-section of the internal channel can be reduced, in particular to zero in the closed position of the valve.

In the first position, which preferably corresponds to the open target position of the valve, the shut-off body inner channel and the remaining sections of the internal channel are preferably aligned with each other, in particular such that the central axis of the shut-off body inner channel is aligned parallel to the central axis of the sections of the internal channel adjoining the shut-off body inner channel. In the second position, which preferably corresponds to the closed target position of the valve, the shut-off body inner channel and the remaining sections of the internal channel are preferably rotated relative to each other.

In one embodiment, the sealing element is annular. In this way, the sealing element can seal the internal channel in the region between the valve housing and the shut-off body over the entire circumference of the internal channel. An annular sealing element is particularly suitable for a spherical shut-off body. The valve housing preferably has a circumferential receptacle in the circumferential direction of the internal channel for receiving the annular sealing element. In this way, the annular sealing element can be securely held between the valve housing and the shut-off body over the entire circumference.

In the initial state, the sealing element is in particular less deformed over the entire circumference than in the deformed state, in particular undeformed. Preferably, the sealing element is unloaded over the entire circumference in the initial state.

In one embodiment, the sealing element has a support body made of a first material and a sealing body made of a second material, wherein the second material has a lower modulus of elasticity than the first material.

In this way, the support body with a higher modulus of elasticity and thus higher stiffness provides sufficient stability for the sealing element, so that the sealing element is not pressed out of its intended position between the valve housing and the shut-off body when the shut-off body is adjusted or by the pressure of a fluid flowing through the internal channel.

Furthermore, the sealing body with the lower modulus of elasticity and thus lower stiffness provides sufficient elasticity for the sealing element to achieve good sealing between the sealing element and the shut-off body and/or the valve housing.

Preferably, the sealing body forms the sealing lip and/or the further sealing lip. In this way, improved sealing between the sealing lip or further sealing lip and the shut-off body or valve housing is achieved.

By dividing the supporting and sealing functions of the sealing element between two components of the sealing element, namely the support body and the sealing body, the material selection for the support body and the sealing body can be optimized for their respective functions. In particular, the materials used no longer necessarily have to possess both supporting and sealing properties, thereby expanding the range of possible materials. Furthermore, the sealing body with the less stiff material results in deposits, in particular compared to conventional sealing elements made of PTFE or PFAS-containing material, being much easier to remove, since the sealing material of the sealing body can be deformed much more elastically.

In addition, the less stiff material of the sealing body allows good sealing even with larger tolerances, in particular the distance between the shut-off body and the valve housing, thereby enabling better tolerance compensation in the valve. In this way, the quality of the valve can be increased and production rejects, for example due to larger tolerances, can be reduced.

Furthermore, the configuration of the sealing element with support body and sealing body has a positive effect on the actuation of the valve, since the mechanical properties, in particular of the material used for the sealing body, enable high sealing performance while still requiring only relatively low torques for actuation.

The support body and the sealing body can in particular be connected to each other in a form-fitting and/or material-bonded manner. For example, the sealing element can be produced by multi-component injection molding, thereby creating a material-bonded connection between the support body and the sealing body. Furthermore, the support body can have one or more openings, in particular openings distributed in the circumferential direction, through which the material of the sealing body extends. In this way, a form-fitting connection between the support body and the sealing body can be achieved.

The sealing body preferably surrounds the support body on two opposite sides, so that the sealing body can seal both to the shut-off body and to the valve housing.

In one embodiment, the sealing element is PFAS-free. Per-and polyfluorinated alkyl substances (PFAS) are suspected of being carcinogenic, so there is a need to avoid these materials and instead use PFAS-free materials, particularly when the valve is used for a drinking water installation.

However, PFAS is still frequently used for sealing elements, as it possesses both supporting and sealing properties. In particular, when using a sealing element with a support body and a sealing body, PFAS-containing materials can be dispensed with in the present valve, and instead PFAS-free materials can be used that provide supporting properties for the support body and sealing properties for the sealing body.

Accordingly, in particular the second material, and preferably both the first material and the second material, are PFAS-free.

The support body may in particular consist of, preferably fiber-reinforced, in particular glass fiber-or carbon fiber-reinforced, plastic. The plastic of the support body may in particular be a polyphthalamide-based plastic (PPA plastic) or a polyphenylene sulfide-based plastic (PPS plastic).

The sealing body in particular comprises or consists of an elastomer. The elastomer may in particular be a synthetic rubber, for example ethylene propylene diene rubber (EPDM) or acrylonitrile butadiene rubber (NBR), in particular hydrogenated acrylonitrile butadiene rubber (HNBR). EPDM is preferably used for drinking water applications. NBR or HNBR is preferably used for gas applications. These synthetic rubbers are in particular PFAS-free and thus allow the production of a PFAS-free valve.

In principle, it is also conceivable to use a PFAS-containing elastomer for the sealing body, for example fluorocarbon rubber (FKM). In this case, however, the valve would not be PFAS-free.

In one embodiment, the sealing element has one or more sealing surfaces opposite the sealing lip and/or the further sealing lip, which rest against the valve housing or the shut-off body. If the sealing lip is intended to rest against the shut-off body in the second position of the shut-off body, the one or more sealing surfaces preferably rest against the valve housing. If the sealing lip is intended to rest against the valve housing in the second position of the shut-off body, the one or more sealing surfaces preferably rest against the shut-off body.

A sealing surface may in particular be formed by a protruding region of the sealing body, for example also by a sealing lip.

The sealing surfaces form a counter-bearing for the sealing lip to rest against the shut-off body or the valve housing. Furthermore, the sealing surfaces provide sealing to the valve housing when the sealing lip seals to the shut-off body, or to the shut-off body when the sealing lip seals to the valve housing.

In the first position of the shut-off body, preferably in the open position of the valve, preferably on one side of the sealing element, the one or more sealing surfaces rest against respective counter-surfaces on the valve housing or the shut-off body, and on the other side of the sealing element, preferably the further sealing lip rests under pre-tension against the shut-off body or the valve housing, and thus together they seal to the valve housing and the shut-off body.

When the shut-off body is moved into the second position, preferably into the closed position of the valve, preferably on one side of the sealing element, the one or more sealing surfaces rest against the counter-surfaces on the valve housing or the shut-off body, and on the other side of the sealing element, the sealing lip and preferably also the further sealing lip rest under pre-tension against the shut-off body or the valve housing, and thus together they seal to the valve housing and the shut-off body.

In one embodiment, a further sealing element is arranged between the valve housing and the shut-off body, wherein one of the sealing element and the further sealing element is arranged between the shut-off body and a part of the valve housing facing the first opening, and the other of the sealing element and the further sealing element is arranged between the shut-off body and a part of the valve housing facing the second opening. Accordingly, a respective sealing element is preferably provided on both sides of the shut-off body for sealing between the shut-off body and the valve housing. The further sealing element may be configured like the sealing element.

In one embodiment, the valve housing has a first connection port with the first opening and a second connection port with the second opening. In this way, the valve can be connected to further components, in particular of a drinking water system. For this purpose, the first and/or second connection port may, for example, have a thread, a press contour, or a flange.

In one embodiment, an actuating element is provided for adjusting the shut-off body. The actuating element is preferably led out of the valve housing so that it can be operated from outside. The actuating element may, for example, be a shaft with a lever, by means of which the shut-off body can be rotated about a rotational axis.

Preferably, an actuator, in particular a motor, is provided for automatically adjusting the shut-off body.

In the described valve, the actuating torques and breakaway torques are reduced, so that significantly smaller actuators with lower maximum output can be used, thereby considerably reducing the installation space, costs, the required power, and the resulting power consumption.

### BRIEF DESCRIPTION OF THE DRAWINGS

Further features and advantages of the valve and its use will become apparent from the following description of exemplary embodiments, with reference to the accompanying drawings.

In the drawings

FIGS. 1a-b show an exemplary embodiment of the valve in the open position,

FIGS. 2a-b show the valve from FIG. 1a-b in the closed position,

FIGS. 3a-b show one of the sealing elements of the valve from FIG. 1a-b,

FIG. 4 shows the valve from FIG. 1a-b in an intermediate position, and

FIG. 5 shows a further exemplary embodiment of the valve.

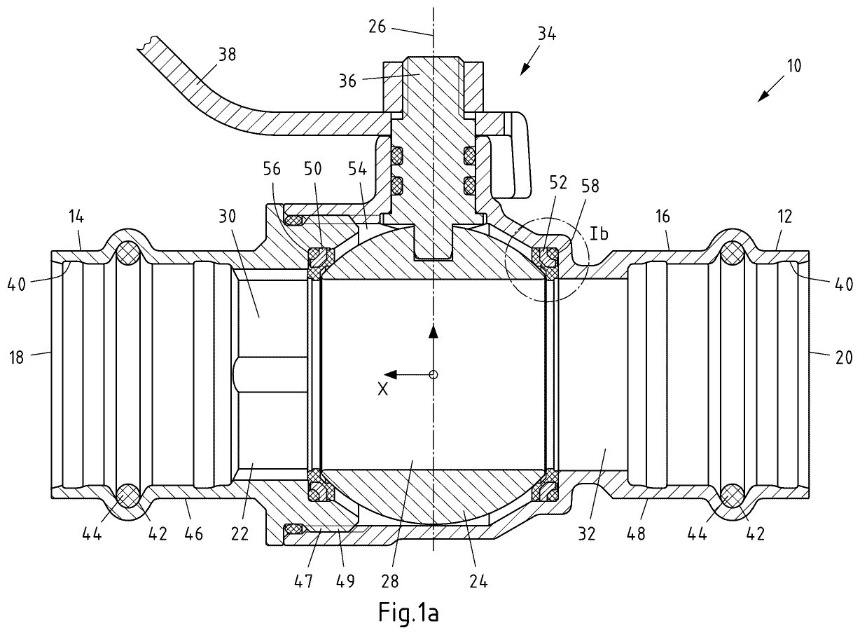

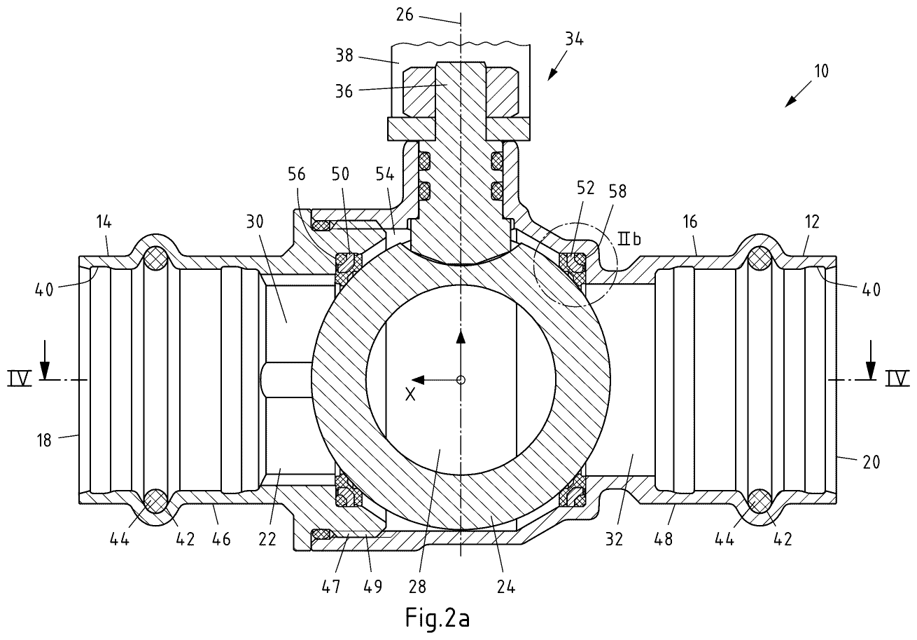

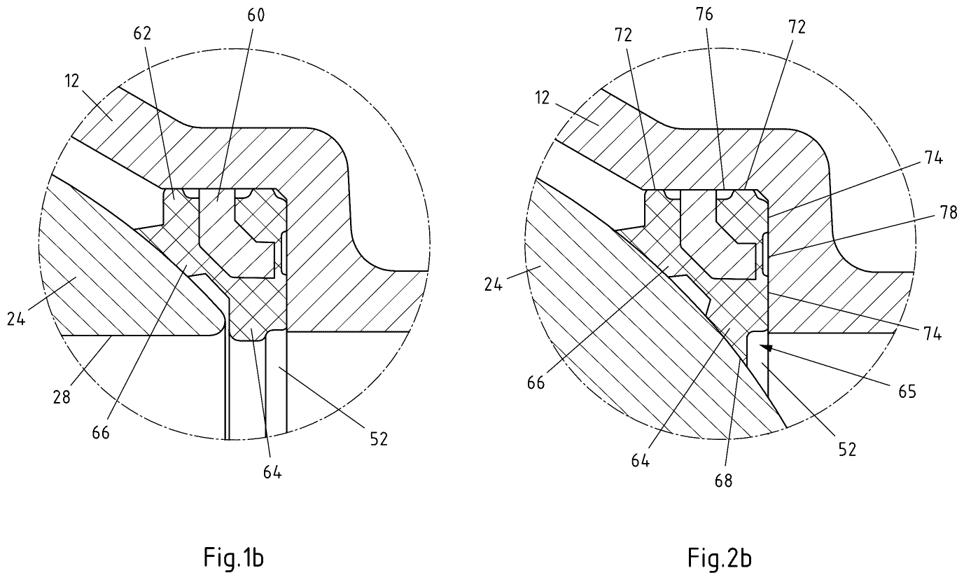

FIGS. 1a-b show an exemplary embodiment of the valve in a schematic view, wherein FIG. 1a is a sectional view and FIG. 1b shows a detail from FIG. 1a corresponding to the area marked “Ib” in FIG. 1a.

### DESCRIPTION OF THE INVENTION

The valve 10 is configured as a ball valve and comprises a valve housing 12 with a first connection port 14 and a second connection port 16. A first opening 18 is provided at the first connection port 14 and a second opening 20 at the second connection port 16. An internal channel 22 runs between the first opening 18 and the second opening 20 in the axial direction of the valve 10.

A spherical shut-off body 24 is arranged in the valve housing 12, which is adjustable, namely rotatable about a rotational axis 26, for regulating a fluid flow through the internal channel 22. For this purpose, the shut-off body 24 has a shut-off body inner channel 28, which forms a section of the internal channel 22 and can be rotated relative to the remaining internal channel sections 30, 32 of the internal channel 22 in the region of the first and second connection ports 14, 16. In FIG. 1a, the shut-off body inner channel 28 is aligned with the internal channel sections 30, 32, so that the cross-section of the internal channel 22 is not reduced or blocked by the shut-off body inner channel 28, and the valve 10 is accordingly open.

FIGS. 2 a-b show the valve 10 with the shut-off body 24 rotated by 90° compared to FIGS. 1a-b. The shut-off body inner channel 28 is thereby rotated relative to the internal channel sections 30, 32 such that the cross-section of the internal channel 22 is reduced to zero, i.e., the valve 10 is completely closed. FIG. 2a shows a sectional view corresponding to FIG. 1a, and FIG. 2b shows a detail of FIG. 2a corresponding to the area marked “IIb” in FIG. 2a.

Thus, FIGS. 1a-b show a first target position (open position) and FIGS. 2a-b a second target position (closed position) of the valve 10. When moving from one target position to the other, the shut-off body 24 can in principle also assume intermediate positions between the open position (FIGS. 1a-b) and the closed position (FIGS. 2a-b), in which the cross-section of the internal channel 22 is reduced to an intermediate value between the full cross-section and zero. Typically, ball valves such as valve 10 are not operated in such intermediate positions for extended periods, but only in the two target positions. The intermediate positions are then only assumed briefly when moving from one target position to the other. For adjusting the shut-off body 24, an actuating element 34 is provided with a shaft 36 fixedly connected to the shut-off body 24 and a lever 38 fixedly connected thereto. The shaft 36 is sealed relative to the valve housing 12, for example as shown in FIGS. 1a-b by means of O-rings.

In the present example, the first and second connection ports 14, 16 each have a press-fit inner contour 40 and a sealing element 44 in the form of an O-ring arranged in a groove 42. In this way, the valve can be connected at the first and second connection ports 14, 16 to a respective pipeline, for example of a drinking water system, by inserting a respective pipe end of the corresponding pipeline into the respective opening 18, 20 and pressing it together with the respective connection port 14, 16. Alternatively, the connection ports 14, 16 may also be configured for a threaded connection, for example by providing an internal or external thread, or may have a flange.

In the present example, the valve housing 12 is of two-part construction with a first housing part 46, which forms the first connection port 14, and a second housing part 48, which forms the second connection port 16. The first and second housing parts 46, 48 are screwed together via corresponding threads 47, 49. The two-part design of the valve housing 12 facilitates the assembly of the individual parts of the valve 10. In particular, during assembly, the shut-off body 24 can be inserted into the second housing part 48 before the first housing part 46 is screwed into the second housing part 48.

For sealing the valve housing 12 relative to the shut-off body 24, an annular sealing element 50, 52 is arranged between the valve housing 12 and the shut-off body 24 at the transition from the internal channel section 30 to the shut-off body 24 and at the transition from the internal channel section 32 to the shut-off body 24, respectively, which holds the shut-off body 24 in position and, in the open position (FIGS. 1a-b) as well as in the closed position (FIGS. 2a-b), seals the valve housing 12 to the shut-off body 24 and thus seals the internal channel 22 in the circumferential direction. In particular, the sealing elements 50, 52 seal the internal channel 22 in the open and closed positions such that fluid conducted through the internal channel 22 is prevented from entering the gap 54 between the valve housing 12 and the shut-off body 24. In this way, in particular in the closed position, it is prevented that fluid flows through the gap 54 around the shut-off body 24.

For positioning the sealing elements 50, 52, the valve housing 12 has a respective annular receptacle 56, 58 in which the respective sealing element 50, 52 is arranged.

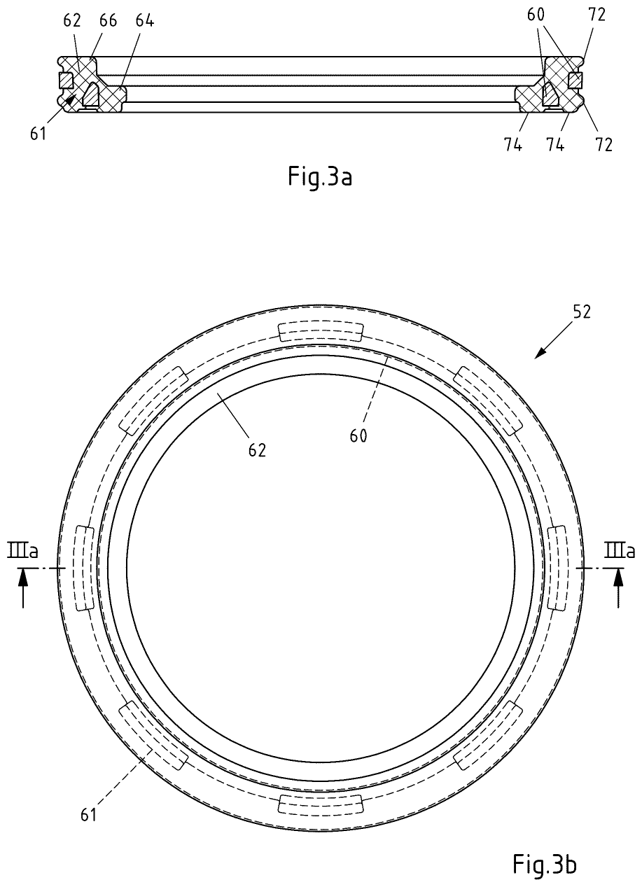

FIGS. 1b and 2b show the cross-section of the annular sealing element 52 in an enlarged sectional view. Furthermore, FIGS. 3a-b show the sealing element 52 in isolation (in the undeformed state), wherein FIG. 3a is a sectional view corresponding to the sectional plane designated “IIIa” in FIG. 3b. The support body 60 is shown in dashed lines in FIG. 3b.

The sealing element 52 has an annular support body 60 and an annular sealing body 62. The cross-sections of the support body 60 and the sealing body 62 can be seen in FIG. 3a; in FIG. 3b, the support body 60 is shown in dashed lines.

The support body 60 is made of a first material and the sealing body 62 is made of a second material, wherein the first material has a higher modulus of elasticity than the second material. In this way, the support body 60 is stiffer and ensures that the sealing element 50 remains securely in the intended position in the receptacle 58 under mechanical load, for example when adjusting the shut-off body 24 or due to the pressure of a fluid flowing through the internal channel 22. Furthermore, the sealing body 62, due to its lower modulus of elasticity compared to the support body 60, is less stiff and therefore better suited for sealing against the shut-off body 24 and the valve housing 12.

The support body 60 may, for example, be made of fiber-reinforced PPA or PPS plastic, and the sealing body 62 may be made of a synthetic rubber, for example EPDM.

The sealing element 52 is produced here by multi-component injection molding, with the elastic sealing body 62 being molded onto the support body 60, so that the sealing body 62 and the support body 60 are materially bonded. In addition, the support body 60 has several openings 61 in the circumferential direction, through which the material of the sealing body 62 extends, so that the sealing body 62 and the support body 60 are also form-fit connected in this embodiment.

On the side of the sealing element 52 facing the shut-off body 24, the sealing body 62 has a first sealing lip 64 and a second sealing lip 66.

The first sealing lip 64 is designed and arranged such that, in the open position of the valve 10, it is in an initial state, in which it is spaced from the shut-off body 24 (see FIG. 1b), and, in the closed position of the valve 10, is in a deformed state relative to the initial state, in which the first sealing lip 64 rests under pre-tension against the shut-off body 24 and is thereby compressed and thus deformed.

The second sealing lip 66 is designed and arranged such that it rests under pre-tension against the shut-off body 24 in every rotational position of the shut-off body 24.

The second sealing lip 66 provides basic sealing both in the closed position (FIGS. 2a-b) and in the open position of the valve 10 (FIGS. 1a-b) as well as in any intermediate positions. Furthermore, the second sealing lip 66 holds the shut-off body 24 in position in the open position, the closed position, and in the intermediate positions. However, permanent deformation of the second sealing lip 66 can result in reduced sealing at this location, in particular when the shut-off body 24 is adjusted. Since the first sealing lip 64 is only deformed when moving from the open to the closed position, the first sealing lip 64, in the closed position, exerts a force counteracting the compression of the sealing lip 64 against the surface of the shut-off body 24, so that in this way good sealing between the sealing element 52 and the shut-off body 24 is achieved. In this way, it can be ensured in particular that, in the closed position, fluid cannot flow around the shut-off body 24 through the gap 54.

The first sealing lip 64 is shaped and arranged relative to the shut-off body 24 such that, in the deformed state when resting against the shut-off body 24 in the closed position, it forms a concave region 65 toward the internal channel 22 opposite the sealing seat 68 of the first sealing lip 64 with the shut-off body 24. The pressure of the fluid present in operation in the internal channel 22, in particular water, thereby exerts a pressing force on the sealing lip 64 in the concave region 65, so that it is pressed more strongly against the shut-off body 24 and thus seals better against it. The pressing force increases with increasing pressure within the internal channel 22, so that reliable sealing is ensured even at high pressures in the internal channel 22.

On the side of the sealing element 52 opposite the sealing lips 64, 66 and facing the valve housing 12, the sealing body 62 has radial sealing surfaces 72 and axial sealing surfaces 74, which rest under pre-tension against respective counter-surfaces 76, 78 of the valve housing 12 and seal the sealing element 52 to the valve housing 12. The counter-surfaces 76, 78 simultaneously serve as a counter-bearing for the sealing lips 64, 66 to rest against the shut-off body 24.

Since the support body 60 and the sealing body 62 have different functions, materials suitable for the respective functions can be used. Furthermore, by providing the first sealing lip 64, materials for the sealing body 62 can also be used that may be more prone to permanent deformation. In this way, the material for the sealing body 62 and the support body 60 can be selected from a broader range of materials.

Preferably, a PFAS-free material is selected for both the support body 60 and the sealing body 62. The first and/or the second material is thus preferably a PFAS-free material.

The sealing element 50 has a structure identical to that of the sealing element 52 and is merely rotated by 180° about the axis 26 according to its arrangement on the opposite side of the shut-off body 24.

The sealing elements 50 and 52 ensure that the valve 10, even after a long period in the open position (see FIGS. 1a-b), can be moved to the closed position (see FIGS. 2a-b) without damage and is reliably sealed there. Furthermore, the use of PFAS-free materials reduces health risks, so that the valve 10 is particularly suitable for use in drinking water installations.

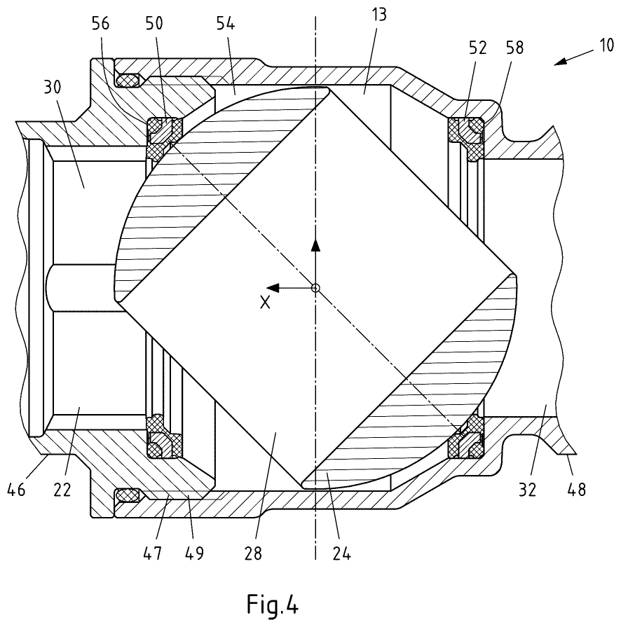

FIG. 4 shows, in a sectional view corresponding to the sectional plane designated “IV” in FIG. 2b, the valve 10 in an intermediate position between the open and closed positions. Unlike in FIGS. 2 a-b, the shut-off body 24 in FIG. 4 is not rotated by 90°, but only by about 45° compared to FIGS. 1a-b. The valve housing 12, the shut-off body 24, and the sealing elements 50, 52 are designed and arranged such that, in the intermediate position, the internal channel 22 is in fluid communication with the gap 54, in the present embodiment via a region 13 in the valve housing 12 between the sealing elements 50, 52 and transverse to the internal channel 22. In this way, the gap 54 is flushed with fluid flowing through the internal channel 22 when the shut-off body 24 is moved between the open and closed positions, so that the fluid contained therein is exchanged and a permanently stagnant fluid volume can be avoided.

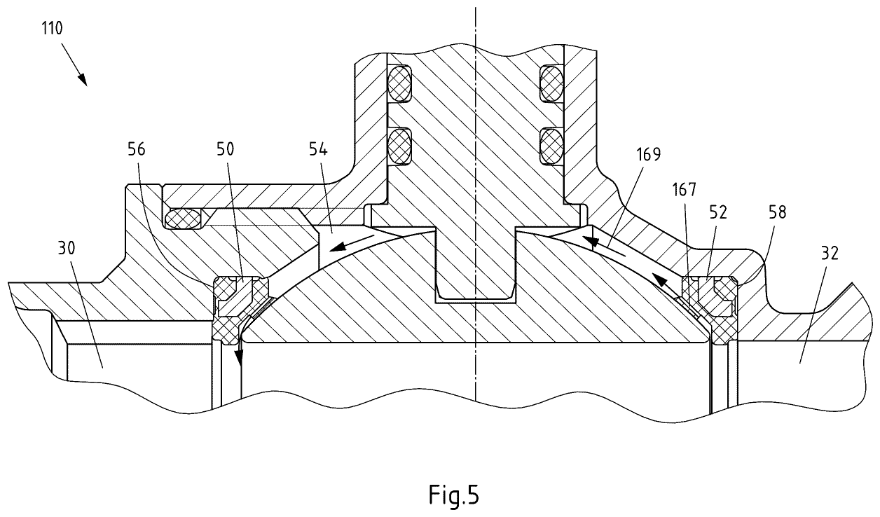

FIG. 5 shows a detail of a further exemplary embodiment of the valve in sectional view. The valve 110 is fundamentally of the same design and operates in the same way as the valve 110. Corresponding components are designated in FIG. 5 with the same reference numerals as in valve 10, and reference is made to the above description of valve 10.

The valve 110 differs from valve 10 only in that, in the region of the respective second sealing lip 66 of the sealing elements 50, 52, openings 167 are provided, for example in the form of channels or perforations, which form a bypass to the second sealing lip 66. In this way, in the open position, when the respective first sealing lip 64 does not rest against the shut-off body 24, on both sides of the sealing elements 50, 52, the openings 167 provide a respective fluid connection between the internal channel 22 and the gap 54, so that the gap 54 is flushed by the fluid conducted through the internal channel 22 (arrow 169). In this way, stagnant fluid, in particular water, in the gap 54 can be avoided in the open position. In this case, the second sealing lip 66 does not have a sealing function, but merely holds the shut-off body 24 in position.

### Reference Numeral List

10, 110 valve
12 valve housing
13 region in the valve housing
14, 16 connection port
18, 20 opening
22 internal channel
24 shut-off body
26 rotational axis
28 shut-off body inner channel
30 internal channel sections
34 actuating element
36 shaft
38 lever
40 press-fit inner contour
42 groove
44 sealing element
46, 48 housing part
47, 49 thread
50, 52 sealing element
54 gap
56, 58 annular receptacle
60 support body
61 openings in the support body
62 sealing body
64, 66 sealing lip
65 concave region
68 sealing seat
72, 74 sealing surface
76, 78 counter-surface
167 openings in the sealing body
169 arrow (fluid flow)

1. A valve, in particular ball valve,
with a valve housing that has at least a first opening and a second opening, between which an internal channel runs, and
with a shut-off body arranged in the valve housing, which can be adjusted to regulate, in particular to shut off or allow the passage of, a fluid flow through the internal channel,
wherein a sealing element is arranged between the valve housing and the shut-off body,
wherein
that the sealing element has an elastic sealing lip, wherein the elastic sealing lip and the shut-off body are designed and arranged relative to each other such that the elastic sealing lip is in an initial state when the shut-off body is in a first position, in particular in a first target position of the valve and that the elastic sealing lip is in a deformed state relative to the initial state when the shut-off body is in a second position, in particular in a second target position of the valve.

2. The valve according to claim 1, wherein the elastic sealing lip, in the deformed state, in particular under pre-tension, rests against the shut-off body or the valve housing.

3. The valve according to claim 1, wherein the sealing element has a further elastic sealing lip, wherein the further elastic sealing lip and the shut-off body are designed and arranged relative to each other such that the further elastic sealing lip, preferably under pre-tension, rests against the shut-off body or the valve housing when the shut-off body is in the first position.

4. The valve according to claim 3, wherein the sealing element has one or more openings as a bypass for the further elastic sealing lip.

5. The valve according to claim 1,
wherein the shut-off body is rotatably mounted in the
valve housing, in particular about a rotational axis, wherein the shut-off body preferably has a shut-off body inner channel.

6. The valve according to claim 1,
wherein the sealing element is annular.

7. The valve according to claim 1,
wherein the sealing element has a support body made of a first material and a sealing body made of a second material, wherein the second material has a lower modulus of elasticity than the first material, wherein the sealing body preferably forms the sealing lip and/or the further sealing lip.

8. The valve according to claim 1,
wherein the sealing element is PFAS-free.

9. The valve according to claim 1,
wherein the sealing element has one or more sealing surfaces opposite the sealing lip and/or the further sealing lip, which sealing surfaces rest against the valve housing or the shut-off body.

10. The valve according to claim 1,
wherein a further sealing element is arranged between the valve housing and the shut-off body, wherein one of the sealing element and the further sealing element is arranged between the shut-off body and a part of the valve housing facing the first opening, and the other of the sealing element and the further sealing element is arranged between the shut-off body and a part of the valve housing facing the second opening.

11. The valve according to claim 1,
wherein the valve housing has a first connection port with the first opening and a second connection port with the second opening.

12. The valve according to claim 1,
wherein an actuating element is provided for adjusting the shut-off body.

13. (canceled)
